(19) United States
(12) Patent Application Publication
(10) Pub. No.: US 2010/0062539 A1
(43) Pub. Date: Mar. 11, 2010

(54) SILICA PARTICLES MODIFIED WITH POLAR ORGANIC MOIETIES

(76) Inventors: Rowell Frederick, Durham (GB); Sundar Latha, Durham (GB)

Correspondence Address: KOLISCH HARTWELL, P.C., 200 PACIFIC BUILDING, 520 SW YAMHILL STREET, PORTLAND, OR, 97204, US

(21) Appl. No.: 12/442,515

(22) PCT Filed: Sep. 24, 2007
(86) PCT No.: PCT/GB2007/050573

§ 371 Date: Nov. 6, 2009

(30) Foreign Application Priority Data
Sep. 22, 2006 (GB) 0618706.6

(51) Int. Cl. G01N 24/00; C07F 7/02

(52) U.S. Cl. 436/173; 556/400; 977/773

(57) ABSTRACT

The present disclosure relates to silica particles and, in embodiments, to organically-substituted silica particles. The particles are useful for the adsorption of compounds, particularly the adsorption and desorption of compounds in for example matrix assisted mass spectroscopy techniques or chromatographic techniques. The present disclosure further relates to such techniques, the preparation of the particles and other subject matter.

### BACKGROUND

The present invention relates to silica particles and, in embodiments, to organically-substituted silica particles. The particles are useful for the adsorption of compounds, particularly the adsorption and desorption of compounds in for example matrix assisted mass spectroscopy techniques or chromatographic techniques. The invention further relates to such techniques, the preparation of the particles and other subject matter.

Two reports describe the use of combinations of tetraethoxysilane (TEOS) and phenyltriethoxysilane (PTEOS) to produce relatively hydrophobic silica aerogels [E. R. Menzel, S. M Savoy, S. J. Ulvick, K. H. Cheng, R. H. Murdock and M. R. Sudduth, Photoluminescent Semiconductor Nanocrystals for Fingerprint Detection, Journal of Forensic Sciences (1999) 545-551] and the corresponding nanoparticles [E. R. Menzel, M. Takatsu, R. H. Murdock, K. Bouldin and K. H. Cheng, Photoluminescent CdS/Dendrimer Nanocomposites for Fingerprint Detection, Journal of Forensic Sciences (2000) 770-773] for use in bioanalysis and biosensor applications. The former report demonstrated that as the proportion of PTEOS increased, the hydrophobicity of the resulting sol gel also increased, whilst the latter report used the particles' hydrophobicity to incorporate the hydrophobic dye, rhodamine 6G into the resulting particles. The nanoparticles were highly fluorescent with the dye being strongly retained within the particles under aqueous conditions.

International patent application PCT/GB2006/050233 (WO2007/017700) describes a method for preparing hydrophobic silica particles, the method comprising reacting together in a single step a mixture of silane ether monomers and organically modified silane ether monomers with a hydrolysing agent, e.g. reacting together in a single step a mixture of TEOS (tetraethoxysilane) and PTEOS (phenyltriethoxysilane) monomers with the hydrolysing agent. The hydrolysing agent, typically an alkali, acts as a catalyst within the reaction. Preferably this catalyst is a hydroxide, for example ammonium hydroxide.

The mixture typically further comprises a water miscible solvent, for example ethanol, and water. The method is typically carried out at ambient temperature. The reaction may be performed overnight or for an equivalent time period, that is to say for between about 12 and about 18 hours. The length of the reaction has an effect on the size of silica particles produced. It is believed that the earlier a reaction is stopped, the smaller are the particles which are formed.

The silane ether monomer, for example TEOS, and the organically substituted silane ether monomer, e.g. PTEOS may be used in ratios (PTEOS:TEOS) of, in particular, 1.2:1 to 1:1.2, preferably 1:1 v/v.

Particles produced by the above method tend to be predominantly nanoparticles, that is to say, of an average diameter of approximately 100 nm to about 900 nm, typically from 200 nm to about 900 nm, typically about 300 nm to 800 nm and particularly 400 nm to 500 nm.

These nanoparticles can be subsequently processed to form microparticles, which can be considered coalesced nanoparticles. The microparticles may be produced using a method comprising the steps of:
i) centrifuging a suspension of particles;
ii) transferring the suspension of hydrophobic silica particles into an aqueous phase;
iii) extracting the suspension from the aqueous phase into an organic phase;
iv) evaporating the organic phase; and
v) crushing and sieving the product obtained in (iv).

The organic phase may be dichloromethane.

In an alternative method of PCT/GB2006/050233 (WO2007/017700), hydrophobic silica nanoparticles are isolated from a reaction product produced from carrying out the previously described method for their manufacture. The hydrophobic silica nanoparticles are isolated using a method which comprises centrifuging the reaction product and suspending it in an aqueous:solvent mixture, preferably a 50:50 mixture. The reaction product is removed from the aqueous: solvent mixture, centrifuged and suspended in a second aqueous:solvent mixture. Preferably, the second aqueous: solvent mixture has a similar proportion of solvent and aqueous component as the first mixture.

The aqueous:solvent mixture is typically a mixture of water and a water-miscible solvent, e.g. ethanol.

The step of suspending the reaction product in an aqueous:solvent mixture and centrifuging it is repeated a plurality of times. Preferably, the composition of the aqueous:solvent mixture is altered to increase the proportion of solvent in the aqueous:solvent mixture over the course of repeated suspensions. The final step may comprise suspending the reaction product in an aqueous: solvent “mixture” which is 0% aqueous:100% solvent. The total number of suspensions is typically from 3 to 10, e.g. 4, 5, 6, 7, 8 or 9. Typically after each suspension except the final suspension the suspensions are centrifuged. The nanoparticles can be stored in the final ethanolic (or other) suspension.

However in order to be able to visualise the above-described particles it is advantageous to incorporate a variety of dyes within them.

As described earlier, the ratio of silane ether monomers, for example, TEOS and organically substituted silane ether monomers, for example PTEOS is preferably about 1:1 v/v. It is at this ratio that the optimum incorporation and therefore retention of a dye molecule within the silica particle is demonstrated.

The particles may be magnetic or paramagnetic. For example, magnetisable microparticles can easily be dusted over fingerprints, using a magnetic wand or other appropriate tool. Thus, the methods for preparing hydrophobic silica particles may further comprise including magnetic or paramagnetic particles in a reaction mixture of silane ether monomers, for example TEOS monomers, and organically modified silane ether monomers, for example PTEOS monomers. The magnetic and/or paramagnetic particles may be any magnetic or paramagnetic component, for example metals, metal nitrides, metal oxides and carbon. Examples of magnetic metals include iron, whilst examples of a metal oxide include magnetite. Carbon may be in the form of, for example, carbon black, fullerene or carbon nanotubes (derivatized or non-derivatized carbon nanotubes).

The inclusion of carbon black results in the particles having a grey colour. The precise colour of the grey particles is dependent on the amount of carbon black included in the TEOS/PTEOS mixture during synthesis. A higher level of carbon black results in a darker particle.

A second international patent application, namely PCT/GB2006/050234 (WO2007/017701), describes the use in fingerprint analysis of hydrophobic silica particles, for example particles as described in International patent application PCT/GB2006/050233 (WO2007/017700). The particles are applied to the fingerprint, usually after the fingerprint is lifted. The hydrophobicity of the silica particles enhances the binding of the particles to the fingerprint. The fingerprint and its associated silica particles are then subjected to matrix assisted mass spectroscopy, e.g. matrix assisted laser desorption/ionisation-time-of-flight mass spectrometry (MALDI-TOF-MS). The silica particles act as the matrix.

The process of analysing a target analyte typically involves placing the analyte, or in this case the analyte adsorbed onto the hydrophobic particles, onto a target support (in commercial practice, this would currently be a stainless steel target plate), inserting this support into a MALDI-TOF-MS analyser, directing a laser on the analyte and measuring the time of flight of the ionised molecules that are formed as a result of the laser illumination. In the event that the hydrophobic particles have not adsorbed an analyte, then of course it is solely the particles which are placed on the support.

A key aspect of the MALDI-TOF-MS process is the ionisation of the analyte, since nonionised analyte molecules will not be detected. Generally, a chemical is applied to the target analyte sample on the target plate and this serves as a matrix which donates or receives electrons to or from the target analyte, resulting in the latter's ionisation and subsequent detection in the TOF-MS system.

Many molecules have dipole moments due to non-uniform distributions of positive and negative charges on the various atoms. Such molecules include non-aromatic and aromatic organic compounds when, in either case, substituted by or containing heteroatoms, some examples of compounds containing both an aromatic ring structure and one or more heteroatoms considered in the following paragraphs.

Polyaromatic compounds such as dioxins (halogenated organic compounds comprising two benzene rings joined by a double oxygen bridge) and related furans (a single oxygen bridge joining two benzene rings) and estrogenic steroids are examples of potentially hazardous chemicals which require monitoring within industrial sites and within the wider environment. There are standard methods which have been developed for the former in a variety of sample types. These include airborne monitoring, in flue ash and soil and in food stuffs. These require complex extraction, clean up and concentration steps prior to gas chromatography (GC)-mass spectrometry (MS), which is generally based on high resolution GC-MS.

Estrogenic and other steroids are also found in environmental samples with the major estrogenic contribution probably deriving from excretion of the synthetic compound, ethynylestradiol (ETED) from users of the female contraceptive pill, and estrone (ES) and 17-β-estradiol which are excreted from females undergoing hormone replacement therapy. Again their analysis from environmental samples is complex following a similar approach to that described for dioxins and related compounds.

Both types of analyte (polyaromatics and steroids share structural similarities in that they are hydrophobic and have aromatic moieties. They also possess dipoles: dioxins and related furans carry poly chloro- or other halogens whereas the estrogenic steroids posses a phenolic substructure.

It would be desirable to provide additional products and methods for use in the processing of polar organic compounds, for example for the purpose of analysis, e.g. to provide methods which are more sensitive than, or are cheaper and/or easier than, current methods. More particularly, there are many processes which require the adsorption and desorption of compounds, for example chromatography can in general terms be said to involve these processes and is commonly used for separation in analysis as well as synthesis. Another such process is matrix assisted laser mass spectrometry, which involves adsorption of the analyte on the matrix and its subsequent release through the action of the laser on the matrix.

### BRIEF SUMMARY OF THE DISCLOSURE

This invention is partly based on the design and synthesis of hydrophobic silica particles to facilitate their binding to polar organic compounds, for example when they have the status of target analytes. This entails changing the composition of the surface determinants presented on the particle's surface to accommodate the structural features and charge distributions present within the polar compound.

The invention is also partly based on the design of hydrophobic silica particles to enable them to act as enhancing agents for the analysis of the target analytes adsorbed onto the surface of the particles. This analysis is carried out by matrix assisted laser desorption/ionisation-time-of-flight mass spectrometry (MALDI-TOF-MS). MALDI is termed surface assisted laser desorption/ionisation (SALDI) when graphite, titanium or silica are used as suspension matrices for MALDI, J. Sunner, E. Dratz and Y.-C. Chen, Graphite Surface-Assisted Laser Desorption/Ionization Time-of-Flight Mass Spectrometry of Peptides and Proteins from Liquid Solutions, Anal. Chem. 67 (1995) 4335; A. Crecelius, M. R. Clench, D. S. Richards and V. Parr, Thin-Layer Chromatography-Matrix-Assisted Laser Desorption Ionisation-Time-of-Flight Mass Spectrometry Using Particle Suspension Matrices, J. Chromatogr. A. 958 (2002) 249. SALDI-TOF-MS is therefore a variant sub-class of MALDI-TOF-MS and the term MALDITOF-MS as used herein includes SALDI-TOF-MS.

It will be recalled that, in the MALDI-TOF-MS process, the analyte is ionised via a matrix which donates or receives electrons to or from the target analyte. The teaching of the present invention includes the modification of hydrophobic particles such that, when they are used as a matrix and stimulated by a laser, the components within the particles assist in the ionisation process so that these classes of compounds can be analysed directly on the surface following their adsorption. Generally in MALDI-TOF-MS, the matrix assisting agent must be in intimate contact with the analyte molecules.

The present invention provides in one aspect silica particles comprising a polar organic moiety. The polar organic moiety may be an organic moiety substituted by a functional group.

The identity of the organic moiety is not critical to the invention but, in some embodiments, it is an aromatic group, for example phenyl or naphthyl. In principle, organic moieties may be substituted with functional groups at any stage of the synthetic process: the functional groups may therefore be present in precursor organically modified silane ether monomers used in synthesis of the particles, or the organic moieties of silane precursors may be substituted with the functional groups prior to synthesis of silica particles; alternatively functional groups may be added during an intermediate stage in the preparation of the particles or after their formation.

The functional groups may serve to impart dipoles to the organic moiety and, in principle, therefore, any functional group containing a heteroatom may function for this purpose, in view of the difference in electronegativity between carbon and heteroatoms. As a matter of practical sense, however, functional groups will be chosen not to be detrimentally unstable or to be unduly reactive with the environment in which the silica particles are intended to be used. Typically, the functional groups contain one or both of oxygen and nitrogen, and exemplary functional groups are nitro, amino, hydroxy and halogen, notably fluorine or chlorine.

The invention provides silica particles which are polar, hydrophobic particles suited to adsorption of polar, hydrophobic materials. For example, silica particles containing functional group-substituted aromatic moieties may beneficially be used for the adsorption of steroids and heteroatom-substituted polyaromatics. The silica particles are therefore useful for adsorption of such compounds, for example in those many processes which involve sequential adsorption then desorption of materials, e.g. MALDO-TOF-MS or chromatographic processes.

Also provided are silica particles comprising an organic moiety capable of both hydrophobic-hydrophobic interactions and an interaction selected from the group consisting of dipole-dipole interactions, hydrogen bonding interactions and charge transfer interactions, and combinations thereof.

Included in the invention, therefore, is a method of performing matrix assisted laser desorption/ionisation-time-of-flight mass spectrometry (MALDI-TOF-MS), comprising

placing into a MALDI-TOF-MS apparatus particles comprising an organic moiety capable of both hydrophobic-hydrophobic interactions and an interaction selected from the group consisting of dipole-dipole interactions, hydrogen bonding interactions and charge transfer interactions, and combinations thereof;

illuminating the particles with a laser;

and measuring the time of flight of the ionised molecules that are formed as a result of the laser illumination. In usual practice, the particles are placed on a support before being inserted into the MALDI-TOF-MS apparatus, and the support is then inserted into the apparatus.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

FIG. 1: MALDI-TOF-MS profile of 17-alpha-ethynylestradiol (ETED) in solution or adsorbed on different nanoparticulate matrix materials, in each case in combination with conventional matrix material DHB.

FIG. 2: MALDI-TOF-MS profiles of blank nanoparticles.

FIG. 3: MALDI-TOF-MS profile of 17-alpha-ethynylestradiol (ETED) in solution or adsorbed on different DHB-free nanoparticulate matrix materials, one being a matrix material according to the invention.

FIG. 4: MALDI-TOF-MS/MS profile of nitrated PTEOS nanoparticles without matrix

### DETAILED DESCRIPTION

### Glossary

DHB: dihydroxybenzoic acid
MALDI-TOF-MS: Matrix assisted laser desorption/ionisation-time-of-flight mass spectrometry, including SALDI-TOF-MS.
MALDI-TOF-MS-MS: Matrix assisted laser desorption/ionisation-time-of-flight mass spectrometry-mass spectrometry
SALDI-TOF-MS: Surface assisted laser desorption/ionisation-time-of-flight mass spectrometry.
SALDI-TOF-MS-MS: Surface assisted laser desorption/ionisation-time-of-flight mass spectrometry-mass spectrometry.
PTEOS NP: hydrophobic silica nanoparticles prepared by reacting PTEOS and TEOS.
PTEOS: phenyltriethoxysilane
TEOS: tetraethoxysilane.

### Particles

There are disclosed herein organically modified silica particles, prepared from silane ether monomers and organically modified silane ether monomers. Exemplary silane ether monomers, as known in the art, include TEOS (tetraethoxysilane) and TMOS (tetramethoxysilane). The organically modified silane ether contains at least one organic moiety linked to silicon through a carbon atom of the organic moiety. An exemplary organically modified silane ether monomer is PTEOS (phenyltriethoxysilane).

Organically modified silica particles of the prior art have organic moieties which are dipole-free hydrocarbyl groups. Included in this invention are organically modified silica particles characterised by organic moieties having dipoles, i.e. polar organic moieties.

The identity of the polar organic moiety is not critical to the invention but it is directly bonded to the silicon of the modified silane monomers through a carbon-silicon bond and, whilst not being bound by theory, it is believed that the organic moiety is similarly directly bound to silicon via a carbon-silicon bond in the silica particles. The organic moiety includes one or more heteroatoms in order to impart polarity; the heteroatoms are typically selected from nitrogen, oxygen and the halogens, although other heteroatoms such as, for example, boron, phosphorus and sulphur are within the scope of the invention. The invention therefore includes silica particles containing organic moieties having at least one functional group.

The invention can be described, therefore, as including silica particles having organic moieties capable of both hydrophobic-hydrophobic interactions and dipole-dipole interactions. In embodiments, and as mentioned further below, there are provided silica particles having organic moieties capable of both hydrophobic-hydrophobic interactions and hydrogen bonding interactions. In other embodiments there are provided silica particles having organic moieties capable of both hydrophobic-hydrophobic interactions and charge transfer (electron donor-acceptor) interactions. Exemplary particles therefore comprise an organic moiety having a hydrophobic hydrocarbyl domain or group, substituted by one or more substituents capable of participating in at least one of the interactions mentioned in this paragraph.

The silica particles may be microparticles or nanoparticles.

In many embodiments, the organic moiety is a hydrocarbyl group substituted by one or more functional groups. The size of the hydrocarbyl group is not critical to the invention but, for example, it may contain from one to eighteen carbon atoms. Typical organic moieties include a monocyclic, bicyclic or tricyclic rings, the rings for example being 5- or 6-membered. The hydrocarbyl moieties may be saturated or unsaturated and, in the latter case, commonly include an aromatic ring structure, for example phenyl or naphthyl. In particular embodiments, the polar organic moiety is a substituted phenyl group. It may also be a substituted naphthyl group.

The hydrocarbyl moieties may be aliphatic, for example alkyl or alkenyl, or alicyclic, for example cyclohexyl or cyclohexenyl.

As previously mentioned, it is a feature of the presently discussed embodiment of the invention that the silica particles contain a hydrocarbyl group substituted by a functional group to impart polarity, for example functional groups containing nitrogen, oxygen or halogen, particularly fluorine or chlorine. The functional group may by way of example be nitro, amino, hydroxy, chloro or fluoro. Amino groups are often unsubstituted but mono- or di-substituted amino is to be mentioned; substituents may be hydrocarbyl groups containing from one to six carbon atoms, e.g. alkyl groups. Other functional groups to mention are carbonyl, imine, oxime. N-oxide, carboxy, nitrile, azide, diazonium, isonitrile, cyanate, isocyanate, and the sulphur analogues of the aforementioned O-containing groups. As a further non-exhaustive list of examples may be mentioned phosphate, sulphate and boronyl.

In embodiments, the functional groups are H-bond donors; in other embodiments they are H-bond acceptors. H-bond donors and H-bond acceptors may associate respectively with H-bond acceptor and H-bond donor groups of adsorbates for the silica particles. Hydrogen bond acceptors include nitro, carbonyl (e.g. as —CHO), nitrile, boronyl and hydroxy. Hydrogen bond donors include primary and secondary amino groups; other hydrogen bond donors include hydroxy and amido groups.

Also contemplated as functional groups are those capable of electron donor-acceptor interactions, i.e. interactions in which an electronegative atom with a free pair of electrons (e.g. nitrogen, as for example in a primary amino group) acts as a donor and binds to an electron-deficient atom that acts as an acceptor for the electron pair of the donor. (See e.g. Karger et al., An Introduction into Separation Science, John Wiley & Sons (1973) page 42.) Typical acceptor atoms/groups are electron deficient atoms or groups, such as cyano, nitrogen in nitro etc, and include a hydrogen bound to an electronegative atom such as HO— in hydroxy and carboxy, —NH— in amides and amines, HS— in thiol etc.

Although the invention does not prescribe a list of acceptable functional groups, it is practical for good sense that the hydrocarbyl groups of the silica particles should be substituted with functional groups which do not suffer from significant instability or unwanted chemical reactivity during the preparation, storage or use of the particles. It is also practical good sense that the substituent functional groups should normally be selected to provide the desired properties to the silica particles, for example improved matrix performance in matrix assisted laser mass spectroscopy or improved (or, if desired, worsened) adsorption properties for selected compounds. Stability and chemical reactivity of functional groups may be judged on the basis of common general knowledge of their chemistry, and functional performance in terms of properties imparted to the silica particles may be determined empirically.

If desired, the functional groups may in turn be derivatised.

A hydrocarbyl or other organic moiety may be substituted by one or more functional groups, e.g. 2, 3 or 4 functional groups. In the case of substitution by multiple functional groups, the functional groups may be the same or different.

Also included are embodiments in which the organic moiety comprises a heterocycle. The heterocycle may be substituted by one or more functional groups as described above in relation to substituted hydrocarbyl groups. Alternatively, the heterocycle may be an unsubstituted polar heterocycle, e.g. nitrogen heterocycles, for example piperazine or piperidine.

It will be appreciated from the aforegoing that the invention includes silica particles containing polar moieties selected from aliphatic, alicyclic and aromatic moieties.

### Synthesis

The silica particles of the invention may be made by modification of known methods for manufacture of organically modified or hydrophobic silica particles, for example as taught by Menzel et al (see above) or in PCT/GB2006/050233 (WO2007/017700).

Thus, a preparative method described in PCT/GB2006/050233 (WO2007/017700) comprises reacting together in a single step a mixture of (1) silane ether monomers, for example, a alkoxysilane and (2) organically substituted silane ether monomers, for example a phenyl modified silicate, with a hydrolysing agent e.g. ammonium hydroxide or another alkali. The silane ether monomers may be tetraalkoxysilanes (abbreviated herein to TAOS). The TAOS's are particularly selected from TEOS (tetraethoxysilane) or TMOS (tetramethoxysilane).

The reaction may be performed at ambient temperature and for a period of 12 to 18 hours in a medium which comprises water miscible solvent, for example ethanol, and water. It is believed that the earlier a reaction is stopped, the smaller the particles which are formed. The silane ether monomer and the organically substituted silane ether monomer may be used in ratios (PTEOS:TAOS) of 1:1 v/v.

The hydrophobic silica particles produced by the above method tend to be predominantly nanoparticles, that is to say, of an average diameter of approximately 100 nm to about 900 nm, typically from 200 nm to about 900 nm, typically about 300 nm to 800 nm and particularly 400 nm to 500 nm. These nanoparticles can be subsequently processed to form microparticles, which can be considered coalesced nanoparticles. The microparticles may be produced using a method which for example comprises the following steps:
i) centrifuging a suspension of particles;
ii) transferring the suspension of hydrophobic silica particles into an aqueous phase;
iii) extracting the suspension from the aqueous phase into an organic phase;
iv) evaporating the organic phase; and
v) crushing and sieving the product obtained in (iv).

Thus, exemplary silica particles are microparticles obtained by reacting monomers as described above and forming a suspension of particles which are centrifuged, extracted into dichloromethane from water, and then dried by evaporation of the organic phase to yield a glass-like sheet of coalesced particles. This is crushed and sieved to obtain particles of the desired size, e.g. of from 1 to 100 μm, more often 10 to 100 μm, for example from 30 μm to 90 μm.

The organic phase preferably comprises an organic solvent which is non-polar or has low polarity. The organic phase may be dichloromethane or another organic solvent for example alkanes, e.g. hexane, toluene, ethyl acetate, chloroform and diethyl ether.

Alternatively, hydrophobic silica microparticles can be obtained from a reaction product containing hydrophobic silica nanoparticles using a method comprising:

(a) centrifuging the reaction product; and

(b) washing the reaction product in a fluid.

The method may comprise repeating steps (a) and (b) a plurality of times. Preferably, the fluid is an aqueous:solvent mixture and is typically a water:organic solvent mixture. Typically, the organic solvent is ethanol. Preferably the initial fluid comprises a mixture of water and organic solvent at a ratio of from about 60 (water):40 (solvent) to about a 40:60 v/v mixture. In other embodiments, the solvent can be, for example, dimethylformamide, n-propanol or iso-propanol.

Typically, the proportion of solvent in the mixture is increased between the initial washing (i.e. suspension) (b) and the final washing (suspension). To obtain microparticles which are coalesced nanoparticles, the final suspension is dried. The microparticles may then be sieved. Once sieved, the microparticles are ready for use.

The microparticles may be considered to be aggregates of smaller silica nanoparticles. It is desirable that the microparticles are of sufficient size to be efficiently captured using face masks and hence not inhaled. Thus, in one embodiment, the silica microparticles have an average diameter of at least 10 μm, typically at least 20 μm. Typically, the microparticles have an average diameter of from about 30-90 μm. In some embodiments, the microparticles have an average diameter of between about 45-65 μm or from about 65 to 90 μm.

The silica particles may be nanoparticles, for example as described above under the heading “BACKGROUND”.

Such hydrophobic silica nanoparticles may be stored in a suspension. The fluid may be an ethanolic aqueous suspension. Alternatively, other organic solvents may be used in place of ethanol in the suspension e.g. dimethylformamide, n-propanol or iso-propanol.

Alternatively, the hydrophobic silica particles can be obtained using other methods in the art, (see for example, Tapec et al NanoSci. Nanotech. 2002. Vol. 2. No. 3/4 pp 405-409; E. R. Menzel, S. M Savoy, S. J. Ulvick, K. H. Cheng, R. H. Murdock and M. R. Sudduth, Photoluminescent Semiconductor Nanocrystals for Fingerprint Detection, Journal of Forensic Sciences (1999) 545-551; and E. R. Menzel, M. Takatsu, R. H. Murdock, K. Bouldin and K. H. Cheng, Photoluminescent CdS/Dendrimer Nanocomposites for Fingerprint Detection, Journal of Forensic Sciences (2000) 770-773).

The term “average diameter” can be taken to mean a “mean diameter” of particles typically formed from the methods of the invention. The term “mean” is a statistical term that is essentially the sum of all the diameters measured divided by the number of particles used in such measurements. The diameters of nanoparticles can be estimated from SEM pictures and the scale used in pictures, and for microparticles the diameter can be estimated from a combination of the sieve size, the results from particle size distribution measurements and from SEM pictures. One way a mean diameter can be determined is by using a Malvern Mastersizer (Malvern Instruments Ltd.)

### Modification of Synthesis to Incorporate a Polar Organic Moiety

In one class of embodiments, the polar organic moiety is incorporated by using in the synthesis an organically modified silane monomer comprising an organic moiety having the characteristics desired in the end product particles, for example the organic moiety may be a polar organic moiety such as, for example, a heterocycle or a carbocycle substituted by a functional group.

In another class of methods, a heteroatom is introduced into the organic moiety after preparation of the silica particles. For example, functional groups or other heteroatom containing groups (e.g. heterocycles) may be introduced using conventional functional group chemistry and/or functional group transformations may be performed as known to the skilled chemist. By way of example, aromatic compounds may be substituted using, for example, aromatic substitution reactions familiar to the skilled chemist. For example, aromatic moieties contained in silica particles may be nitrated using a mixture of concentrated nitric and sulphuric acids. If desired, the nitro group may be reduced to an amino group. The amino group may in turn be diazotised and used to prepare azobridged derivatives with phenols and related compounds, for example phenol or tyrosine. Aromatic compounds may be halogenated by the action of halogen in the presence of a Lewis acid or, in the case of fluorine, using the techniques commonly known to organofluorine chemists. Aromatic compounds may be converted to phenyls by reaction with sulphuric acid to create the corresponding aromatic sulphuric acid, followed by fusion with alkali (e.g. KOH).

In the other methods, functional groups or other groups capable of participating in a desired non-hydrophobic interaction are added and/or transformed at an intermediate step in the preparation, e.g. after preparation of organically-substituted silicon nanoparticles but prior to their coalescence into microparticles.

After preparation of the derivatised particles, i.e. after addition of the desired functional group, the particles are conveniently separated from the reaction medium, e.g. by centrifugation, and then washed. After washing, the particles may be crowned and crushed, and optionally sieved.

### Use

The particles of the invention are useful for adsorbing polar materials. Suitably, the particles of the invention will have enhanced affinity and/or intimacy with one or more compounds having features (moieties, functional groups, electron distribution, hydrogen bond acceptors or donors etc) which will interact with those of the organic moieties of the particles. For example, polar hydrophobic silica particles will have enhanced affinity and/or intimacy with polar organic compounds, thereby providing a use for the particles in the processing of polar organic compounds, whether for example in analysis or synthesis.

A particular application of the particles is MALDI-TOF-MS. The polar organic moieties of the particles will adsorb suitable polar organic molecules. For example, in the case of particles comprising planar aromatic groups, the particles will be suitable for adsorption of polar, planar aromatic compounds, for example dioxins, furans, steroids and sterols. The adsorbed compounds may then be identified and/or measured, for example by MALDI-TOF-MS.

Irrespective of the effects of polarity on the adsorptive properties of silica particles, the introduction of molecular dipoles is believed to enhance the properties of the particles as matrix materials for MALDI-TOF-MS by facilitating charge transfer to adsorbed compounds having molecular dipoles with which the dipoles on the particles may associate (positive region to negative region).

Additional matrix materials, for example DHB, are not used in embodiments of the matrix assisted uses and methods. The disclosure therefore includes silica particles free or substantially free of other matrix materials.

A further application of the particles is as matrix material for MALDI-TOF-MS/MS or SALDI-TOF-MS/MS. MALDI-TOF-MS/MS and SALDI-TOF-MS/MS are examples of tandem mass spectrometry. Tandem mass spectrometry typically involves multiple steps of mass selection or analysis, usually separated by some form of fragmentation. MALDI-TOF-MS/MS and SALDI-TOF-MS/MS typically fragment specific sample ions inside a mass spectrometer and therefore provide further characteristic structural information about a residue. Thus, in one embodiment, the method comprises identifying the resulting fragment ions to provide identification of the parent molecule.

The silica particles of the invention may be used in a liquid chromatographic setting, for example in affinity chromatography or fluid injection analysis (FIA). For example, silica particles of the invention may have adsorbed thereon a polar organic compound which is linked to or comprises a label, for example a fluorescent dye. These particles are placed in a reactor of a fluid analysis system and a sample containing a suspected analyte having affinity for the microparticles is injected into the system. If the analyte is present, it will displace labelled molecules, which will be detectable at the output of the FIA system and potentially quantifiable using a standard curve.

It is contemplated also that the particles of the invention may find application in affinity chromatography.

### EXAMPLES

### Example 1

### Preparation of Hydrophobic Silica Particles

### Methods

Carbon black suspension was supplied by Cabot Corp, Cheshire UK. All other chemicals were purchased from Sigma-Aldrich, Dorset UK.,

This method was adapted from the preparation of blank silica based nanoparticles. [W. Stober, A. Fink and E. Bohn, J. Colloid Interface Science, vol 26, 62 (1968)]. The basic method is as follows; 30 ml ethanol, 5 ml dH₂O, 2.5 ml tetraethoxysilane and 2.5 ml phenyltriethoxysilane were mixed in a centrifuge tube. To this was added. 2 ml ammonium hydroxide solution (28%) to initiate nanoparticle formation and the solution rotated overnight. The resulting particulate suspension was extracted repeatedly with methylene dichloride/water or ethanol/water (50:50 in both cases). The suspension was centrifuged (5 min at 3000 rpm). The supernatant was removed and 10 ml dH₂O and the same volume of dichloromethane were added. The suspension was rotated for a further 10 minutes, prior to the suspension being centrifuged again. The aqueous upper layer of the solution was removed and further aliquots of water and dichloromethane added. This process of rinsing and centrifugation was repeated 4 times until no further water:dichloromethane could be added. After such time, the particles were dried down from the dichloromethane in an incubator at 40° C.

Once dry, the particles were crushed in a mortar and pestle prior to being sieved to produce suitable particle sizes. The hydrophobic particles were sieved through brass test sieves with bronze mesh (Endecot Ltd., London UK) by hand. The particle size fractions used in this study were below 63 μm. A Malvern Mastersizer (Malvern Instruments Ltd., Malvern, UK) was used to verify the particle size distributions.

### Example 2

### Preparation of Carbon Black-Containing Particles

For carbon black-containing particles, 5 ml of a 1:100 fold dilution of the supplied carbon black suspension in water was added to the precursor solution placed in a centrifuge tube, prior to the addition of the silanisation reagents.

### Example 3

### Derivatisation of Organically Modified Silica Particles

To a clean dry round bottomed flask weighed 300 mg of PTEOS NP and added 2 ml of conc. H₂SO₄. Placed on a ice bath with a magnetic stirrer and added 500 μl of conc. HNO₃ dropwise. After addition left the reaction to proceed for 1 hr at 4° C. After 1 hr the mixture was poured into 40 ml of deionised cold water taken in a 50 ml centrifuge tube. Centrifuged the particles for 3 minutes at 3000 rpm followed by removal of the supernatant. Added 40 ml of deionised water, vortexed the nanoparticles for 30s, centrifuged for 3 minutes at 3000 rpm followed by the removal of the supernatant. The washing step was carried out 6 more times. After the final wash, transferred the nanoparticles to an evaporating dish and air dried for 2 days. Once the particles were dry, grounded in a mortar and pestle and stored in a air tight container.

### Example 4

### Adsorption Experiments

Particles were produced following modified synthetic routes. Four types of particles were formed

1. Hydrophilic particles based on TEOS only
2. Hydrophobic particles based on mixtures of PTEOS and TEOS as described above
3. Hydrophobic particles based on nitrated TEOS/PTEOS-derived particles (“PTEOS NP”)
Method-4. Particles based on (2) above but embedded Carbon Black nanoparticles
a) Ethynylestradiol (ETED) onto Silica Nanoparticles

A stock solution of ETED (from Sigma Aldrich) (1 mg/ml) was prepared in absolute ethanol. A suspension of silica nanoparticles (5 mg/ml) was prepared in a 1/1 by volume mixture of ethanol and deionised water. An aliquot (200 μl) of this suspension was added to a polypropylene microcentrifuge tube (1.5 ml polypropylene microcentrifuge tube from Sterilin), containing ethanol:water mixture (1/1 by volume) (700 μl). To this was added an aliquot of ETED (100 μl) containing 100 μg of ETED. The tube was closed using the integral stopper and inverted for 1 h using a Rotator Drive STR4, Stuart Scientific Supplies, UK inverter set at speed 1. This experiment was repeated with examples of each type of silica nanoparticle described above, and as a control the experiment was performed without any particles when the particle suspension was replaced with an aliquot of ethanol/water (200 μl). At the end of the incubation step the tubes were centrifuged for 3 min at 3000 rpm in a microcentrifuge (Jouan, BR4 i, Thermo Electron Corporation). The supernatant was aspirated off and d-H₂O added (1 ml). The particles were resuspended by vortex mixing for 30 sec when the tubes were re-centrifuged as before. This wash cycle was repeated a further three times and the final supernatant of d-H₂O removed. At this point the washed particles were re-suspended in 100 μl of ethanol/water mixture as above.

### MALDI-TOF-MS Analysis

A Kratos Axima-CFR MALDI-TOF-MS (Shimadzu Biotech, Manchester UK.) system was used throughout with the following settings; laser power 90, reflectron positive mode, ion gate off, P. Ext 250, and mass range 1-500. Samples were pipetted onto stainless steel target plates also supplied by Shimadzu. For calibration, aliquots of the target analyte ETED 10 μl of stock solution containing 1 mg/ml of the analyte) were mixed with aliquots of 2,5-dihydroxybenzoic acid (DHB) (10 μl of a stock solution ethanol containing 1 mg/ml), and 1 μl of this mixture was pipetted onto the pre-cleaned surface of the target plate. The spots were air dried for 30 min.

An aliquot (1 μl) of the washed suspension from the absorption experiment with each type of silica particle was deposited onto the target plate together with the predispensed standard. Finally an aliquot (1 μl) of the stock ETED solution was directly applied to the target plate and allowed to dry without any added DBH matrix. These were allowed to dry for 30 min prior to MS-analysis

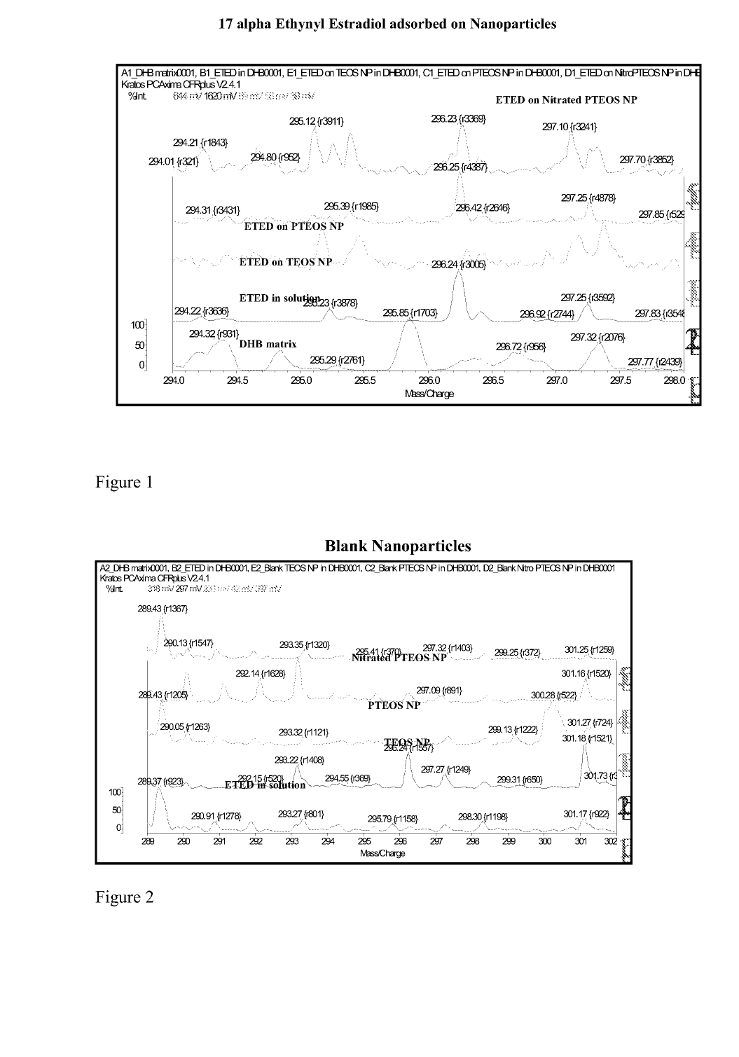

As seen in the ETED solution profile of FIG. 1, ETED exhibits a molecular ion at m/z at 296 and the DHB matrix does not interfere with this peak. The spectra for the MALDI TOF-MS of the nanoparticles with adsorbed ETED are also shown in FIG. 1. No peak at 296 is seen with the hydrophilic particles derived from TEOS but peaks are seen for ETED in the hydrophobic particles derived from PTEOS and the nitrated PTEOS-derived particles, demonstrating that ETED binds to these particles. A clear peak for ETED at 296.23 is observed indicating that hydrophobic silica nanoparticles can be used to both adsorb ETED and as an agent for enhancing the MALDI-TOF-MS of the adsorbed chemical.

The spectra for the particles themselves plus DHB are shown in FIG. 2. No peaks at 296 are seen indicating that the particles do not interfere with the spectra of the adsorbed ETED. FIG. 2 shows the spectra for the three types of particles but in the absence of DHB matrix.

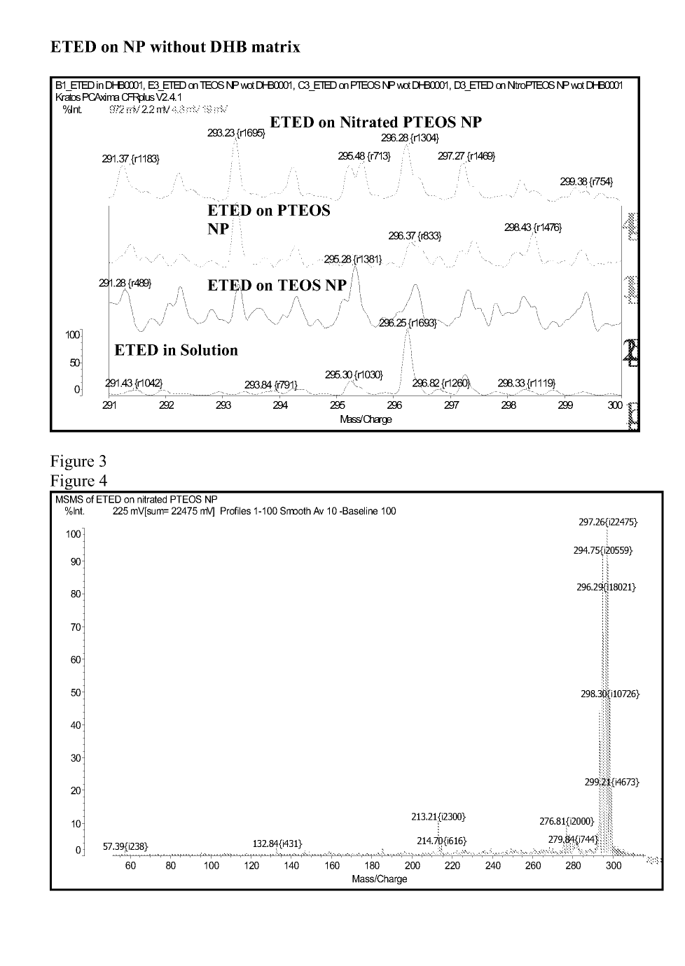

FIG. 3 shows the spectra for the three types of particles but in the absence of DHB matrix. A clear peak for ETED at 296.28 is observed in the case of the nitrated particles indicating that this type of particle can be used to both adsorb ETED and as an agent for enhancing the MALDI-TOF-MS of the adsorbed chemical. It is to be noted in FIG. 3 that the peak at 296.28 in the case of the nitrated particles does not have a corresponding peak for the non-nitrated particles.

MALDI-TOF MS/MS was carried out as shown in FIG. 4.

The examples therefore demonstrate the surprisingly improved performance of functionalised particles as disclosed herein when used with a functionalised (polar) organic compound.

### Discussion

The results clearly demonstrate that silica particles which include polar hydrophobic groups, in this case nanoparticles formed by nitration of particles synthesised using TEOS and PTEOS, can be used to adsorb large hydrophobic but dipole-containing molecules such as estrogenic steroids and related steroids and hydrophobic polychlorinated molecules such as dioxins from aqueous solutions.

The chemicals adsorbed onto the surface of these particles can then be directly detected using MALDI-TOF-MS either with a conventional matrix enhancing agent such as 2,5-dihydroxybenzoic acid, or directly without the need for this added agent. Further analysis of the chemicals e.g. identification of characteristic fragment ions of the chemicals, can be carried out using MALDI-TOF-MS/MS as shown in FIG. 4.

Finally the particles may be packed into bioreactor columns and then used with a flow injection analysis system for the analysis of steroids and other polar hydrophobic compounds. This suitably employs detection of a fluorescent steroid such as coumesterol that is pre-adsorbed onto the particles and is then displaced when the target analytes are injected into the bioreactor.

1.-32. (canceled)

33. The use of a silica particle comprising a polar organic moiety as a matrix material for matrix assisted laser desorption/ionisation-time-of-flight mass spectrometry (MALDI-TOF-MS).

34. The use of claim 33, wherein the MALDI-TOF-MS is used for detecting and/or quantifying a polar organic compound.

35. The use of claim 34, wherein the silica particle comprises a polar aromatic moiety and the polar organic compound is aromatic.

36. A method of performing MALDI-TOF-MS, comprising:
placing into a MALDI-TOF-MS analyser particles comprising an organic moiety capable of both hydrophobic-hydrophobic interactions and an additional interaction selected from the group consisting of dipole-dipole interactions, hydrogen bonding interactions, and charge transfer interactions, and combinations thereof;
illuminating the particles with a laser; and
measuring the time of flight of the ionised molecules that are formed as a result of the laser illumination.

37. The method of claim 36, wherein the particles have adsorbed thereon at least one analyte.

38. The method of claim 37, wherein the analyte is a substance capable of the same interactions as the organic moiety.

39. The method of claim 36, wherein the particles are selected from the group consisting of nanoparticles having a size of less than about 1 μm and microparticles having a size of from about 1 μm to less than about 1000 μm.

40. The method of clam 36, wherein the particles comprise a polar organic moiety which comprises a hydrocarbyl moiety substituted by one or more functional groups.

41. The method of claim 40, wherein the functional groups are selected from nitro, substituted or unsubstituted amino, hydroxy, halo, carbonyl, imine, oxime, N-oxide, carboxy, nitrile, azide, diazonium, isonitrile, cyanate, isocyanate, and the sulphur analogues of the aforementioned O-containing functional groups.

42. The method of claim 41, wherein the functional groups are selected from nitro, amino, hydroxyl, and halo.

43. The method of claim 40, wherein the hydrocarbyl moiety comprises an aromatic ring.

44. The method of claim 43, wherein the hydrocarbyl moiety is phenyl or naphthyl.

45. The method of claim 36, which comprises performing MALDI-TOF-MS/MS.

46. The method of 36, wherein the particles are obtainable by a process involving reaction of a silane ether monomer and an organically-substituted silane ether monomer.

47. A MALDI-TOF-MS material comprising a silica particle having a polar organic moiety.

48. The material of claim 47, wherein the polar organic moiety comprises a hydrocarbyl moiety substituted by one or more functional groups.

49. The use of a silica particle comprising a polar organic moiety to adsorb a polar organic compound.

50. The use of claim 49, further comprising at least partial desorption of the adsorbed compound.

51. The use of claim 49, further comprising chromatography or fluid injection analysis.

52. The use of claim 51, wherein the chromatography or fluid injection analysis includes monitoring for displacement of the adsorbed polar organic compound upon contacting of the particles with a sample.

53. In a MALDI-TOF-MS method, the improvement comprising the use of particles which comprise a polar organic moiety.
